(19) United States
(12) Patent Application Publication
(10) Pub. No.: US 2013/0247105 A1
(43) Pub. Date: Sep. 19, 2013

(54) SMART SUBSCRIBE BUTTON ON WATCH

(71) Applicants: Slave Jovanovski, San Francisco, CA (US); Brian Glick, San Francisco, CA (US)

(72) Inventors: Slave Jovanovski, San Francisco, CA (US); Brian Glick, San Francisco, CA (US)

(73) Assignee: GOOGLE INC., Mountain View, CA (US)

(21) Appl. No.: 13/422,821

(22) Filed: Mar. 16, 2012

(51) Int. Cl. H04N 21/462

(52) U.S. Cl. 725/46

(57) ABSTRACT

A smart subscribe button on watch is presented. In response to a user request for a watch page, a channel associated with the watch page requested by a user is identified. Subscription information of the user is obtained. A determination is made of whether the user is subscribed to the channel associated with the watch page based on the subscription information of the user. If the user is subscribed to the channel, the watch page is modified to reflect the user subscription to the channel associated with the watch page, wherein the modified watch page is to be presented to the user in response to the user request.

### TECHNICAL FIELD

Embodiments of the present invention relate to the field of video watching services and, more particularly, to a smart subscribe button on a watch page.

### BACKGROUND

On the Internet, content hosting websites allow users to upload, view, and share digital content. Such digital content may include audio clips, movie clips, TV clips, and music videos, as well as amateur content such as video blogging and short original videos. Typically, users are directed to digital content on a content hosting site via a Uniform Resource Locator (URL) link shared by another user, or via a search for particular content on the content hosting site. The URL link clicked on by a user directs the user to a watch page that plays the digital content for the user.

The content hosting site can include one or more channels. A channel is a mechanism for providing certain digital content to subscribers. Digital content for the channel can be selected by a user, uploaded by a user, selected by a content provider, or selected by a broadcaster. Users can subscribe to one or more channels. Upon subscribing, the user can view his or her subscriptions from the homepage of the content hosting site or by clicking on a “Subscriptions” link. However, when a user is viewing digital content on a watch page of the content hosting website, the user typically does not know whether he or she is subscribed to the channel associated with the digital content on the watch page. Moreover, making a database request to obtain a user's subscription information each time the user requests to load a watch page (e.g., view a video, listen to audio, etc.) is very expensive, as the watch page may be loaded many times (e.g., billions) per day by many different users.

### SUMMARY

In one embodiment, a method to provide a smart subscribe button on watch is presented. In response to a user request for a watch page, a channel associated with the watch page requested by a user is identified. Subscription information of the user is obtained. A determination is made of whether the user is subscribed to the channel associated with the watch page based on the subscription information of the user. If the user is subscribed to the channel, the watch page is modified to reflect the user subscription to the channel associated with the watch page, wherein the modified watch page is to be presented to the user in response to the user request.

In additional embodiments, computing devices for performing the operations of the above described embodiments are also implemented. Additionally, in embodiments of the invention, a computer readable storage media stores methods for performing the operations of the above described embodiments.

### BRIEF DESCRIPTION OF THE DRAWINGS

The present invention will be understood more fully from the detailed description given below and from the accompanying drawings of various embodiments of the invention.

FIG. 1 illustrates an exemplary system architecture, in accordance with one embodiment of the present invention.

FIG. 2 illustrates a smart subscribe module, in accordance with one embodiment of the present invention.

FIG. 3 illustrates a watch page, in accordance with one embodiment of the present invention.

FIG. 4 is a flow diagram illustrating one embodiment for a method of generating a smart subscribe button on a watch page.

FIG. 5 is a block diagram of an exemplary computer system that may perform one or more of the operations described herein.

### DETAILED DESCRIPTION

Embodiments of the invention pertain to a smart subscribe button on a watch page. A watch page may be a webpage that plays digital content or a webpage that embeds a link to digital content that is played by a digital content player. The digital content played on the watch page can be a video, music, etc. The watch page can include a first portion that plays the digital content (viewing portion) and another portion that displays information about the digital content (e.g., channel information) and a user's relationship to the digital content (e.g., subscription information). A watch page may be loaded and/or viewed by a large number of users (e.g., simultaneously or during a short time period). A channel may represent one or more selections of digital content (e.g., digital content chosen by a user, uploaded by a user, chosen by a content provider, chosen by a broadcaster, etc.). A user can subscribe to one or more channels that the user is interested in. For example, a user can play digital content, such as a video, belonging to a channel “X.” If the user decides that the user is interested in viewing additional digital content in channel “X” or viewing the same digital content again, the user can subscribe to channel “X.” A user of a content hosting site can subscribe to channels using, for example, a watch page, a homepage, a channel page or any other similar page of the content hosting site. In addition, a user may subscribe to different channels at various points in time. The content hosting site may store a user's subscription information that identifies the channels subscribed to by the user.

Embodiments of the present invention provide a user with a convenient way to know whether he or she is subscribed to a channel associated with a watch page when viewing the watch page. For example, a user can subscribe to a number of channels over a period of time. When a user loads a watch page to play digital content from a channel, the user's subscription to the channel is reflected on the watch page for the requested digital content using a subscribe button. This subscribe button is referred to herein as a “smart” subscribe button because it provides up-to-date information on the watch page about the user's subscription to the channel associated with the watch page. The smart subscribe button is generated by determining whether the user is subscribed to the channel associated with the watch page based on the subscription information of the user. If the user is subscribed to the channel, the watch page is modified to reflect the user's subscription to the channel associated with the watch page.

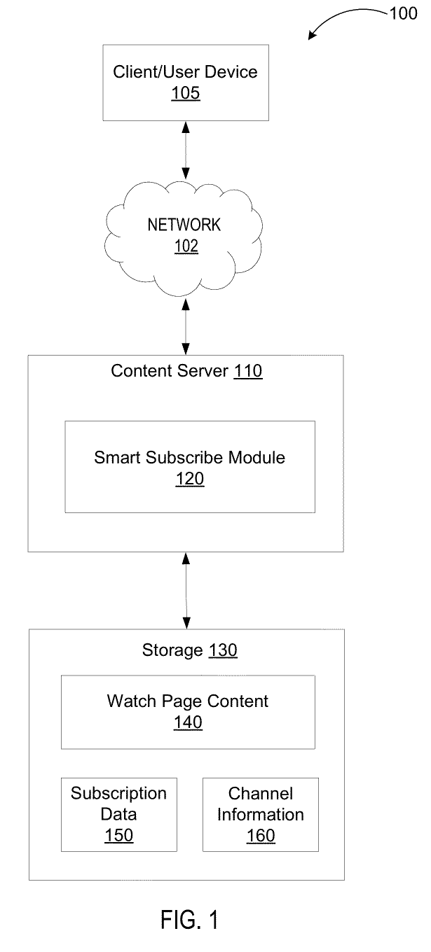

FIG. 1 illustrates an exemplary system architecture 100, in accordance with one embodiment of the present invention. System 100 comprises a client/user device 105 in communication with (e.g., coupled to) a content server 110 over a network 102, and a storage system 130. The network 102 may be a private network (e.g., a local area network (LAN), a wide area network (WAN), intranet, etc.), a corporate network (e.g., a private network for an organization such as a corporation), a broadcast network, a public network (e.g., the Internet), a wired network (e.g., Ethernet network), a wireless network (e.g., an 802.11 network) and/or a cellular network (e.g., a Long Term Evolution (LTE) network).

The client/user device 105 may be any type of computing device, for example, a device including a processor, a computer-readable medium, and a memory. In some embodiments, the client/user device 105 may be executing a browser application or other application adapted to communicate over Internet related protocols (e.g., TCP/IP and HTTP) and/or display a user interface. While only a single client/user device 105 is shown in FIG. 1, system 100 may support a large number of concurrent sessions with many client/user devices 105.

The content server 110 may include computing devices that have a wide range of processing capabilities such a personal computer (PC), a server computer, a personal digital assistant (PDA), a smart phone, a laptop computer, a netbook computer, a tablet device, and/or any machine capable of executing a set of instructions (sequential or otherwise) that specify actions to be taken by that machine. Embodiments of the invention may operate within a single server device or on multiple server devices.

In one embodiment, the content server 110 provides digital content (e.g., digital video, streaming video, images, digital music, streaming music, etc.) to one or more of the client/user device 105. For example, the content server 110 may provide a streaming video requested by a user for playback on the client/user device 105 via the network 102.

Storage 130 can include one or more writable persistent storage devices, such as memories, tapes or disks. Although each of content server 110 and storage system 130 are depicted in FIG. 1 as single, disparate components, these components may be implemented together in a single device or networked in various combinations of multiple different devices that operate together. Examples of devices may include, but are not limited to, servers, mainframe computers, networked computers, process-based devices, and similar type of systems and devices.

Storage 130 may include watch page content 140, subscription data 150 and channel information 160. Watch page content 140 may include digital content for a watch page. For example, the digital content for a watch page can include the streaming video displayed on the watch page, audio played on the watch page, etc. Subscription data 150 may include subscription data for users that can access digital content (e.g., registered users of a content hosting website). The subscription data 150 may include channels that a user has subscribed to, digital content that the user has liked, etc. Channel information 160 may include identification information for various channels, such as an identifier of the channel (e.g., name) and one or more identifiers (e.g., names) of digital content associated with the channel (e.g., digital content selected by a user that owns the channel). In embodiments of the invention, the content server 110 notifies end users of the types of information that are stored on storage 130, and provides the end users the opportunity to opt-out of having such information collected, analyzed, and/or shared.

In some embodiments, storage 130 is deployed across one or more datacenters. A datacenter is a facility used to house a large number of storage devices. Data in storage 130 may be replicated across the multiple datacenters in order to provide reliability, availability, and scalability (RAS) features and/or to allow fast load times for the presentation of content on the content hosting website. The manner of replication of data may be selected by a user, may be selected based on one or more replication algorithms, etc.

During operation of system 100, a user accesses system 100 via client/user device 105 over network 102. The content server 110 receives communications from the client/user device 105, and processes and/or directs these communications accordingly.

As discussed above, conventionally, when a user loads digital content to play on a watch page, information related to the user's relationship to the digital content is not current. For example, the watch page may not display whether the user is subscribed to the channel associated with the digital content played on the watch page. In another example, the watch page may not display whether the user has previously indicated that he or she “likes” the digital content. Embodiments of the present invention address this problem by providing digital content requested by the user together with current information about the user relationship to the digital content.

In particular, in one embodiment, when a user requests digital content to view, the content server 110 receives the request and generates a watch page. The watch page may include digital content from watch page content 140 stored in storage system 130, a channel associated with the digital content played on the watch page based on channel information 160, and a smart subscribe button. In one embodiment, the content server 110 includes a smart subscribe module 120 that identifies a channel associated with the requested watch page and obtains subscription information associated with the user. The channel associated with the requested watch page may be identified using channel information 160 stored in the storage system 130. For example, the channel information 160 may identify various watch pages and channels associated with individual watch pages, and the smart subscribe module 120 may select channels associated with the watch page requested by the user. In one embodiment, the channel information 160 includes the channel information for each channel that includes the digital content stored in watch page content 140. For example, if watch page content includes a video called “Jack Sparrow,” the channel information 160 would store channel information for one or more channels in the content hosting website that include (have selected) the video “Jack Sparrow.”

Subscriptions of the user may be determined using subscription data 150 stored in the storage system 130. For example, the subscription data 150 may identify channels that one or more users are subscribed to. In one embodiment, the subscription data 150 specifies subscriptions of one or more users subscribed to the channels identified in the channel information 160. For example, if the channel information 160 includes the channel information for a channel called “XYZ,” the subscription data 150 would specify one or more users that have subscribed to the channel “XYZ.”

In some embodiments, the watch page content 140, the subscription data 150, and the channel information 160 are obtained from a datacenter containing the data that is “closest” to the user. The datacenter that is closest to the user may be determined based on physical or logical distance, load balancing, whether the datacenter contains other data requested by the user, the amount of traffic on the datacenter, etc. By selecting the datacenter that is closest to the user, the latency of obtaining the data from the system 100 can be reduced by tens to hundreds of milliseconds per request.

In one embodiment, the datacenter that is closest to the user is determined by selecting the datacenter that is in a similar geographic region of the user. In some embodiments, the similar geographic location is calculated using the distance from the geographic location of the user to the geographic locations of the available datacenters. For example, if a user is in California and there is a datacenter located in California, the California datacenter would be selected as the datacenter from which to obtain the data.

In one embodiment, the datacenter that is closed to the user is determined by using load balancing to determine which datacenter currently has the least load. In this embodiment, the loads for the datacenters are compared, and the datacenter with the smallest load is selected. For example, if there are two datacenters, datacenter A and datacenter B, and datacenter A is currently being heavily utilized (e.g., 80%) and datacenter B is currently not highly utilized (e.g., 10% utilization), datacenter B would be selected as the datacenter from which to obtain the data.

In one embodiment, each datacenter is made up of datacells that store data. In this embodiment, the datacell that stores and serves the watch page may be selected as the datacell from which to obtain the data. In one embodiment, if the datacell that serves the watch page is heavily loaded, the next physically close datacell is selected as the datacell from which to obtain the data.

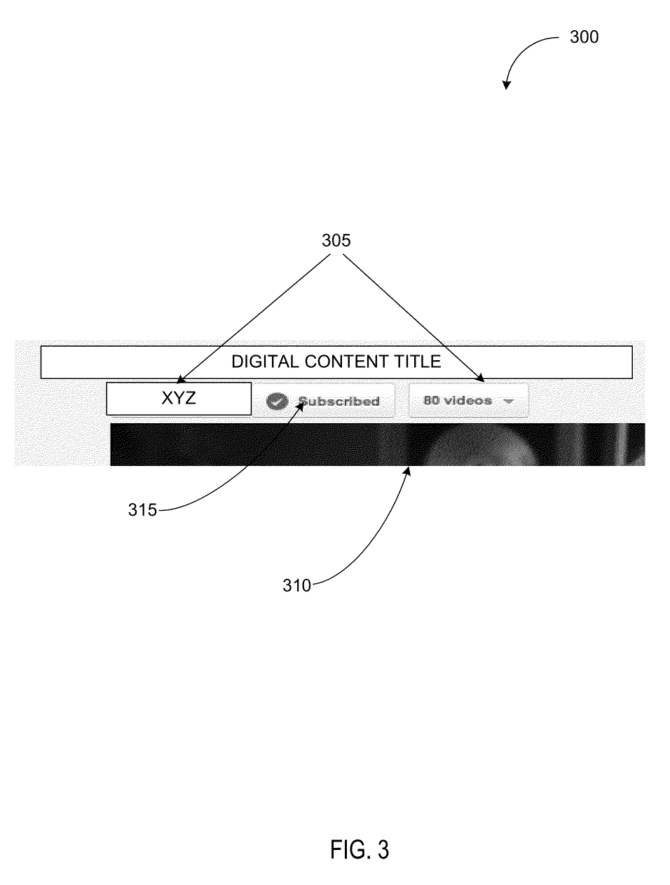

The smart subscribe module 120 provides an indication of a user subscription to the channel associated with the watch page. In one embodiment, the smart subscribe module 120 provides the indication by determining whether the user is subscribed to the channel associated with the watch page based on the subscription information of the user, and if the user is subscribed to the channel, modifying the smart subscribe button on the watch page. The watch page may then be provided to client/user device 105 and presented to the user using an application (e.g., a web browser) on the client/user device 105. For example, the watch page may specify whether the user is subscribed to the channel associated with the digital content and/or watch page, whether the user has previously liked the digital content, etc. An exemplary watch page including a smart subscribe button is discussed in more detail below in conjunction with FIG. 3.

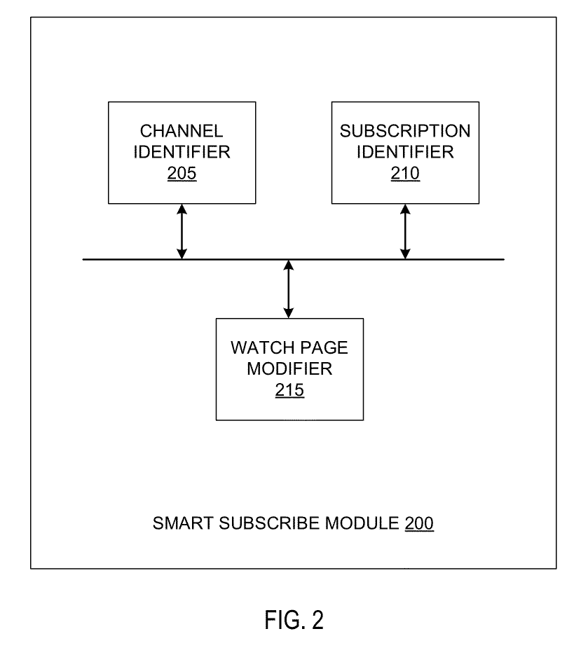

FIG. 2 illustrates a smart subscribe module 200, in accordance with one embodiment of the present invention. The smart subscribe module 200 may include a channel identifier 205, a subscription identifier 210, and a watch page modifier 215. More or less components may be included in the smart subscribe module 200 without loss of generality.

The channel identifier 205 may identify a channel associated with digital content selected by a user to be played on a watch page, a channel associated with the owner of the digital content (e.g., the user that created, uploaded, or owned the channel), or a channel associated with the watch page. In one embodiment, the channel identifier 205 identifies the channel using channel information 160 in storage 130, shown in FIG. 1. In another embodiment, the channel identifier 205 obtains channel information from other computing devices (e.g., other servers not shown in the figures, such as a datacenter) via the network 102 or may obtain the channel information from a memory (e.g., a hard disk, flash memory, random access memory (RAM), etc.).

The subscription identifier 210 may obtain subscription information associated with the user requesting (e.g., selecting digital content to be played on) a watch page. The subscription identifier 210 may obtain information to identify the user requesting the watch page (e.g., user login information) from metadata associated with the digital content or metadata associated with the watch page prior to obtaining the subscription information for the user. The subscription identifier 210 may then determine subscriptions of the user based on subscription data 150 in storage 130, shown in FIG. 1. In another embodiment, the subscription identifier 210 obtains subscription information from other computing devices (e.g., other servers not shown in the figures) via the network 102 or obtains the channel information from a memory (e.g., a hard disk, flash memory, random access memory (RAM), etc.). In one embodiment, the subscription information for the user is stored in the same datacenter that stores the digital content requested by the user. In an alternate embodiment, the subscription information for the user is stored in a different datacenter than the datacenter that stores the digital content requested by the user.

The watch page modifier 215 may determine whether to modify a watch page for digital content selected by a user based on the channel information obtained by channel identifier 205 and the subscription information identified by subscription identifier 210. The watch page modifier 215 may determine whether the user is subscribed to the channel by determining whether the channel identified by channel identifier 205 matches (e.g., is equivalent to) a channel listed in the subscription information identified by subscription identifier 210. If the watch page modifier 215 determines that the identified channel matches the subscription information (the user is subscribed to the channel), the watch page modifier 215 may modify the watch page to reflect the user subscription to the channel associated with the watch page and/or digital content. In one embodiment, a smart subscribe button on the watch page is modified to reflect the user subscription to the channel associated with the digital content on the watch page (e.g., a checkmark is included on the smart subscribe button). In one embodiment, if the watch page modifier 215 determines that the identified channel does not match the subscription information (the user is not subscribed to the channel), the watch page modifier 215 does not modify the watch page. In an alternate embodiment, if the watch page modifier 215 determines that the identified channel does not match the subscription information, the watch page modifier 215 modifies the watch page to indicate that the user is not subscribed to the channel associated with the digital content (e.g., an “X” is included on the smart subscribe button, the color of the smart subscribe button is modified, etc.).

FIG. 3 is an exemplary watch page 300 in accordance with one embodiment of the present invention. The watch page 300 includes channel information 305, digital content 310, and smart subscribe button 315. In some embodiments, channel information 305 includes the name of the channel, a number of different digital contents (e.g., videos) available in the channel, a drop down option to list the names of the different digital contents, etc. Channel information 305 includes the channel name “XYZ” and “80 videos” to present to a user that there are 80 videos in XYZ channel. Channel information 305 further presents a small arrow next to the “80 videos.” In one embodiment, when a user clicks on the arrow, a menu appears listing all the videos associated with XYZ channel. In an alternate embodiment, when a user clicks on the arrow, a popup window including a graphic representation (e.g., picture of a single frame from the video) of one or more of the videos in XYZ channel appears on the watch page.

The digital content 310 represents the digital content requested by the user on the watch page. Although a portion of a video is shown as digital content 310, it should be understood that in other embodiments, other types of digital content may be shown in the watch page 300. For example, an image (e.g., a JPEG) may be shown in the watch page 300. In another example, digital music (e.g., an MP3) may be played in the watch page 300. In one embodiment, the watch page 300 further comprises user interface (UI) elements (not shown in the figure), such as buttons, slide bars, menus, to control the playback of the digital content 310. For example, the watch page 300 may include a volume control slide bar. In another example, the watch page 300 may include buttons, such as “play,” “pause,” “stop,” “fast forward,” and “rewind” buttons to control the playback of the digital content 310.

The smart subscribe button 315 is presented in watch page 300, and provides a user information about the user's relationship with the digital content 310 for the user that requested the watch page 300. The smart subscribe button 315 includes a checkmark and the text “Subscribed”, which informs the user that the user is currently subscribed to the channel 305 associated with the watch page 300 and/or the digital content 310 displayed on the watch page 300. The checkmark may have the same or different color than the text. It should be understood that in other embodiments, other graphic representations and/or text can be presented to a user to provide information about the user's relationship with the digital content 310.

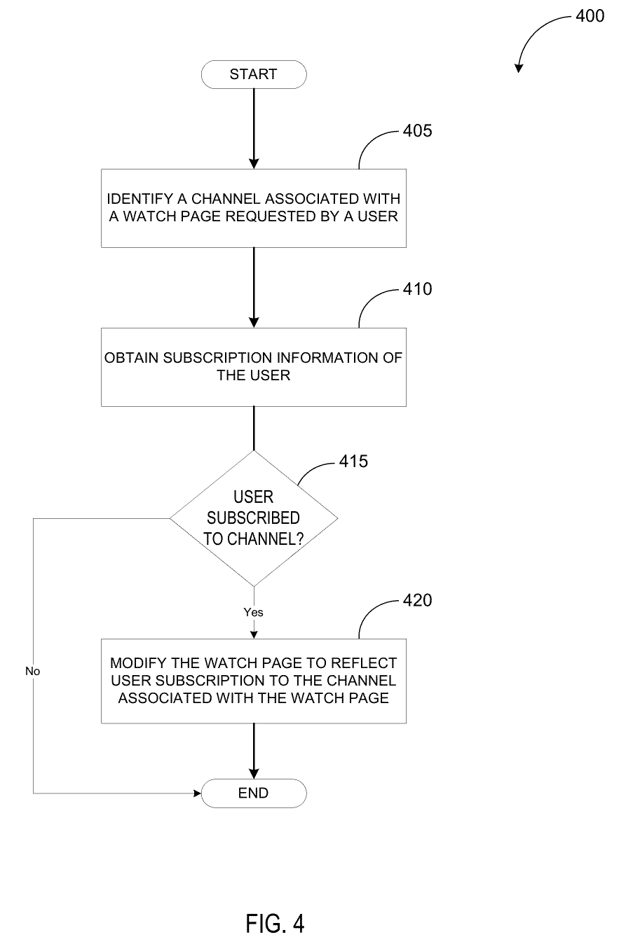

FIG. 4 is a flow diagram illustrating an embodiment for a method 400 of providing a smart subscribe button on watch. The method 400 may be performed by processing logic that may include hardware (e.g., circuitry, dedicated logic, programmable logic, microcode, etc.), software (e.g., instructions run on a processing device to perform hardware simulation), or a combination thereof. In one embodiment, the method 400 is performed by a server (e.g., the content server 110 of FIG. 1).

Referring to FIG. 4, the method 400 identifies a channel associated with a watch page requested by a user (block 405). A watch page may be requested by a user from a content provider, such as a content hosting website. In some embodiments, the watch page may be requested by a user by clicking on a link (e.g., URL) or a graphic representation for the digital content (e.g., picture). Upon requesting the digital content, a watch page including the digital content and information associated with the digital content may be obtained by the content provider. The watch page may be obtained by submitting a request to a datacenter for the digital content and information associated with the digital content.

In one embodiment, the channel associated with a watch page requested by a user is identified based on the code (e.g., HTML) of the watch page. In this embodiment, the code includes channel information to be displayed on the watch page, such as the name of the channel associated with the digital content. In an alternate embodiment, the channel associated with a watch page requested by a user is identified using channel information that is stored separately from the watch page.

In one embodiment, a channel associated with (e.g., assigned to) digital content is stored in a data container (e.g., file, database cell, etc.) when the digital content is uploaded or saved to the content provider. The data container, including the channel information, may be stored in the same datacenter that stores the digital content or may be stored in a datacenter that is different than the datacenter that stores the digital content. In an alternate embodiment, the channel information for the digital content is included in metadata associated with the digital content. In this embodiment, once the digital content for the watch page is obtained from the datacenter, the channel information is also obtained by parsing or reading the metadata.

At block 410, subscription information associated with the user is obtained. In some embodiments, prior to requesting a watch page, the user should provide login and/or identification information (e.g., user name, password, etc.) such that the digital content provider can identify the user. The user login or identification information may be used to request subscription information for a user.

The subscription information associated with the user is obtained by submitting a request that includes the user information to a datacenter storing the subscription information of the user. In one embodiment, the subscription information request is submitted to the datacenter storing the channel information identified at block 405. The subscription information for a user may be created when a user subscribes to a channel (e.g., clicks on a subscribe button). The channel information, such as the name of the channel, is stored in subscription information associated with the user. Each time a user subscribes to a channel, the user's subscription information may be updated to include channel information for that channel. In one embodiment, the user's subscription information is stored in the same datacenter that stores the digital content and/or the channel information for the watch page. In this embodiment, the load time for the watch page is decreased because of the efficiency provided by storing the user's subscription information, the digital content, and/or the channel information in the same datacenter. In some embodiments, only a single request is required to request the user's subscription information, the digital content, and/or the channel information from the datacenter.

In some embodiments, data stored by a digital content provider is replicated across multiple datacenters for reliability, availability, and scalability (RAS). In some embodiments, subscription information for a user that is subscribed to a channel associated with digital content is stored in and replicated to the same datacenters as the digital content and/or channel information in order to provide faster load times or other benefits to the user. In other embodiments, subscription information for a user is not stored to or replicated to the same datacenters as the digital content.

At block 415, a determination is made of whether the user is subscribed to the channel associated with the watch page based on the subscription information of the user. The determination may be made by determining whether the channel associated with the watch page matches (e.g., is equivalent to) a channel listed in the subscription information for the user.

In one embodiment, if the channel associated with the watch page does not match the channel listed in the subscription information for the user, the method 400 ends. In an alternate embodiment, if the channel associated with the watch page does not match the channel listed in the subscription information for the user, processing logic modifies the watch page to indicate that the user is not subscribed to the channel associated with the watch page. For example, the watch page may be modified to include an “X” on the smart subscribe button, the color of the smart subscribe button may be changed, “Not subscribed” may be included on the smart subscribe button, etc. If the channel associated with the watch page matches a channel listed in the subscription information for the user, the method 400 proceeds to block 420.

At block 420, the watch page is modified based on the subscription information for the user and the channel associated with the watch page to indicate that the user is subscribed to the channel associated with the watch page. In one embodiment, a subscribe button on the watch page is modified to indicate that the user is subscribed (e.g., smart subscribe button 315 of FIG. 3).

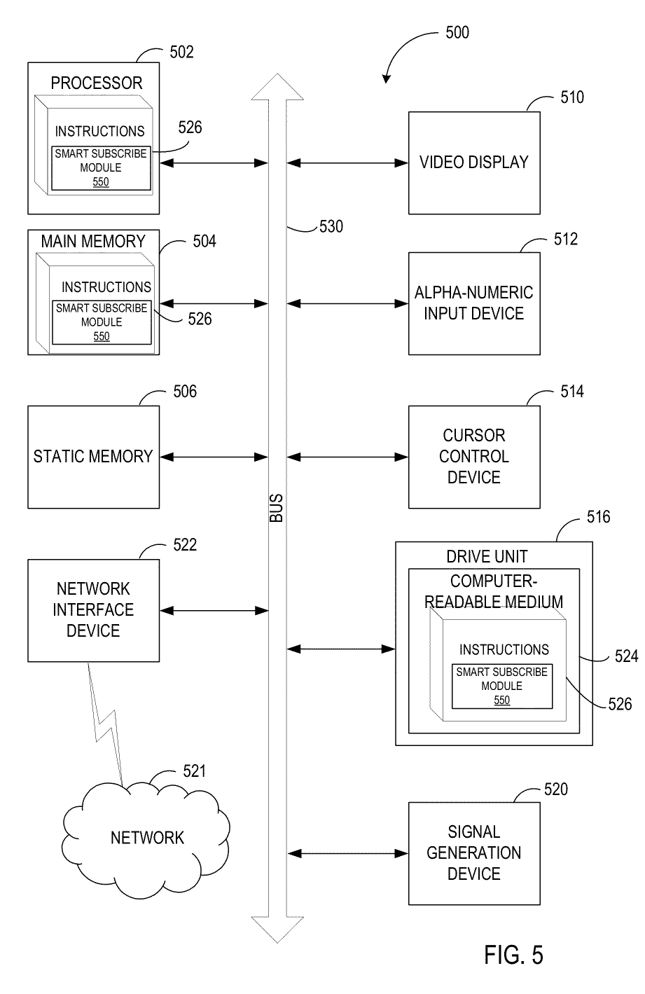

FIG. 5 illustrates a diagrammatic representation of a machine in the exemplary form of a computer system 500 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 500 includes a processing device (processor) 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage device 518, which communicate with each other via a bus 508.

Processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 502 may also be one or more special-purpose processing devices such as an application specific integrated circuit (ASIC), a field programmable gate array (FPGA), a digital signal processor (DSP), network processor, or the like. The processor 502 is configured to execute instructions 526 for performing the operations and steps discussed herein.

The computer system 500 may further include a network interface device 522. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 520 (e.g., a speaker).

The data storage device 518 may include a computer-readable storage medium 524 on which is stored one or more sets of instructions 526 (e.g., software) embodying any one or more of the methodologies or functions described herein. The instructions 526 may also reside, completely or at least partially, within the main memory 504 and/or within the processor 502 during execution thereof by the computer system 500, the main memory 504 and the processor 502 also constituting computer-readable storage media. The instructions 526 may further be transmitted or received over a network 574 via the network interface device 522.

In one embodiment, the instructions 526 include instructions for a smart subscribe module 550, which may correspond to smart subscribe module 120 of FIG. 1, and/or a software library containing methods that call an object detection/recognition engine. While the computer-readable storage medium 524 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present invention may be practiced without these specific details. In some instances, well-known structures and devices are shown in block diagram form, rather than in detail, in order to avoid obscuring the present invention.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “segmenting”, “analyzing”, “determining”, “enabling”, “identifying,” “modifying” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

1. A method, implemented by a server computing system programmed to perform the following, comprising:
in response to a user request for a watch page, identifying, by the computing system, a channel associated with the watch page requested by a user, wherein the watch page is a webpage that embeds a link to digital content that is played by a digital content player;
obtaining subscription information of the user;
determining whether the user is subscribed to the channel associated with the watch page based on the subscription information of the user; and
if the user is subscribed to the channel, modifying, by the computing system, the watch page to reflect the user subscription to the channel associated with the watch page, wherein the modified watch page is to be presented to the user in response to the user request, wherein modifying the watch page comprises updating the watch page to indicate that the user is subscribed to the channel associated with the watch page.

2. The method of claim 1, wherein the subscription information of the user is obtained from a first datacenter that is associated with a second datacenter, wherein the second datacenter provides the watch page.

3. The method of claim 1, wherein the subscription information of the user is obtained from a datacenter that is physically closest to the user.

4. The method of claim 1, wherein the subscription information of the user is obtained from a storage system comprising a plurality of datacenters, wherein the subscription information is obtained from a datacenter in the storage system having a smaller load than another datacenter in the storage system.

5. The method of claim 1, wherein the subscription information of the user is obtained from a datacenter that provides the watch page.

6. The method of claim 1, further comprising:
receiving a request from the user to subscribe to the channel associated with the watch page; and
updating the subscription information of the user to include data associated with the channel.

7. The method of claim 6, further comprising:
storing the subscription information of the user in the datacenter associated with the watch page.

8. The method of claim 6, further comprising:
replicating the subscription information of the user to one or more datacenters that replicate the watch page.

9. The method of claim 1, wherein the modifying comprises:
updating a graphic representation on the watch page to reflect the user subscription to the channel associated with the watch page.

10. The method of claim 9, wherein the graphic representation is a subscribe button for the channel.

11. A non-transitory computer readable storage medium having instructions that, when executed by a processing device, cause the processing device to perform operations comprising:
in response to a user request for a watch page, identifying a channel associated with the watch page requested by a user, wherein the watch page is a webpage that embeds a link to digital content that is played by a digital content player;
obtaining subscription information of the user;
determining whether the user is subscribed to the channel associated with the watch page based on the subscription information of the user; and
if the user is subscribed to the channel, modifying the watch page to reflect the user subscription to the channel associated with the watch page, wherein the modified watch page is to be presented to the user in response to the user request, wherein modifying the watch page comprises updating the watch page to indicate that the user is subscribed to the channel associated with the watch page.

12. The non-transitory computer readable storage medium of claim 11, wherein the subscription information of the user is obtained from a first datacenter that is associated with a second datacenter, wherein the second datacenter provides the watch page.

13. The non-transitory computer readable storage medium of claim 11, wherein the subscription information of the user is obtained from the datacenter that provides the watch page.

14. The non-transitory computer readable storage medium of claim 11, wherein the instructions, when executed by the processing device, cause the processing device to perform further operations comprising:
receiving a request from the user to subscribe to the channel associated with the watch page; and
updating the subscription information of the user to include data associated with the channel.

15. The non-transitory computer readable storage medium of claim 14, wherein the instructions, when executed by the processing device, cause the processing device to perform further operations comprising:
storing the subscription information of the user in the datacenter associated with the watch page.

16. The non-transitory computer readable storage medium of claim 14, wherein the instructions, when executed by the processing device, cause the processing device to perform further operations comprising:
replicating the subscription information of the user to one or more datacenters that replicate the watch page.

17. The non-transitory computer readable storage medium of claim 11, wherein the modifying comprises:
updating a graphic representation on the watch page to reflect the user subscription to the channel associated with the watch page.

18. The non-transitory computer readable storage medium of claim 17, wherein the graphic representation is a subscribe button for the channel.

19. The non-transitory computer readable storage medium of claim 11, wherein the subscription information of the user is obtained from a datacenter that is physically closest to the user.

20. The non-transitory computer readable storage medium of claim 11, wherein the subscription information of the user is obtained from a storage system comprising a plurality of datacenters, wherein the subscription information is obtained from a datacenter in the storage system having a smaller load than another datacenter in the storage system.

21. A computing device comprising:
a memory; and
a processing device coupled to the memory, wherein the processing device is configured to:
in response to a user request for a watch page, identify a channel associated with the watch page requested by a user, wherein the watch page is a webpage that embeds a link to digital content that is played by a digital content player;
obtain subscription information of the user;
determine whether the user is subscribed to the channel associated with the watch page based on the subscription information of the user; and
if the user is subscribed to the channel, modify the watch page to reflect the user subscription to the channel associated with the watch page, wherein the modified watch page is to be presented to the user in response to the user request, wherein modifying the watch page comprises updating the watch page to indicate that the user is subscribed to the channel associated with the watch page.

22. The computing device of claim 21, wherein the processing device is further configured to receive a request from the user to subscribe to the channel associated with the watch page and update the subscription information of the user to include data associated with the channel.

23. The computing device of claim 22, wherein the processing device is further configured to store the subscription information of the user in the datacenter associated with the watch page.

24. The computing device of claim 22, wherein the processing device is further configured to replicate the subscription information of the user to one or more datacenters that replicate the watch page.

25. The computing device of claim 21, wherein the processing device is further configured to update a graphic representation on the watch page to reflect the user subscription to the channel associated with the watch page.

26. The computing device of claim 21, wherein the subscription information of the user is obtained from a datacenter that is physically closest to the user.

27. The computing device of claim 21, wherein the subscription information of the user is obtained from a storage system comprising a plurality of datacenters, wherein the subscription information is obtained from a datacenter in the storage system having a smaller load than another datacenter in the storage system.

28. The method of claim 1, wherein the channel associated with the watch page represents one or more selections of digital content.

29. The method of claim 1, wherein the channel associated with the watch page comprises an identifier for the channel and one or more identifiers for digital content associated with the channel.

30. A method, implemented by a server computing system programmed to perform the following, comprising:
in response to a user request for a watch page, identifying, by the computing system, a channel associated with the watch page requested by a user, wherein the watch page is a webpage that plays digital content;
obtaining subscription information of the user;
determining whether the user is subscribed to the channel associated with the watch page based on the subscription information of the user; and
if the user is subscribed to the channel, modifying, by the computing system, the watch page to reflect the user subscription to the channel associated with the watch page, wherein the modified watch page is to be presented to the user in response to the user request, wherein modifying the watch page comprises updating the watch page to indicate that the user is subscribed to the channel associated with the watch page.
